(19) United States
(12) Patent Application Publication
(10) Pub. No.: US 2006/0152457 A1
(43) Pub. Date: Jul. 13, 2006

(54) Cholesteric liquid crystal display device and method for driving cholesteric liquid crystal display device

(76) Inventors: Masaki Kitaoka, Fukushima City (JP); Toshiaki Kamata, Fukushima City (JP)

Correspondence Address: RATNERPRESTIA, P O BOX 980, VALLEY FORGE, PA, 19482-0980, US

(21) Appl. No.: 10/529,503

(22) PCT Filed: Sep. 27, 2002
(86) PCT No.: PCT/JP02/10016

§ 371 Date: Oct. 25, 2005

(51) Int. Cl. G09G 3/36

(52) U.S. Cl. 345/87

(57) ABSTRACT

A method for driving a liquid crystal display device in which a liquid crystal is driven in a matrix using a plurality of common electrodes and segment electrodes, which are crossed oppositely. While common drive voltage waveforms from each common electrode are sequentially applied to a cholesteric liquid crystal display device, segment electrode drive voltage waveforms from each segment electrode are applied to the device. There is no period of time during which the same voltage is applied to all common electrodes at the same time in a period of time from the application of the hold voltage waveform to the first common electrode to the application of the reset voltage waveform to the last common electrodes, and there is a period of time during which the same voltage is applied to all segment electrodes at the same time.

### TECHNICAL FIELD

The present invention relates to a liquid crystal display apparatus (LCD) and a method for driving a liquid crystal display device, particularly to a cholesteric liquid crystal display apparatus and a method for driving a cholesteric liquid crystal display device in which voltage waveforms are applied to a liquid crystal layer from a plurality of common electrodes and segment electrodes oppositely crossed to each other.

### BACKGROUND ART

A cholesteric liquid crystal apparatus has advantages such that a bright display is possible using a reflection of outer light, a display content is not erased even when a power supply is off, and a large capacity display may be realized in a simple matrix drive. Therefore, a cholesteric liquid crystal apparatus is recently attractive in a field of an electronic paper. On the other hand, a cholesteric liquid crystal apparatus has a disadvantage such that a drive speed is slow. The resolution for this disadvantage has been required.

In view of this problem, U.S. Pat. No. 5,748,277 has proposed a drive method referred to as a Dynamic Drive Scheme (DDS) method. A drive voltage waveform in the DDS method is shown in FIG. 1. The voltage waveform includes a reset period of time to cause a liquid crystal to a homeotropic alignment state, a select period of time to select that the final alignment state is to be a planar state, focal conic state, or a state therebetween, a hold period of time to hold an alignment state selected in the select period of time, and a non-select period of time required for a simple matrix drive.

As an example, a timing of voltages applied to common electrodes for driving a simple matrix liquid crystal device having 16 common electrodes is shown in FIG. 2. A reset voltage waveform, a select voltage waveform, a hold voltage waveform, and a non-select voltage waveform are sequentially applied to the common electrodes shifting a select period of time. It is noted that the reset, select, hold, and non-select voltage waveforms correspond to the voltage waveform in the reset, select, hold, and non-select periods of time, respectively. As the select period of time may be smaller than 1 msec in a room temperature, the DDS method is suitable for a high speed drive.

In an interval A in FIG. 2, it is required that the reset voltage waveforms are applied to the common electrodes COM 11-16, the select voltage waveform to the common electrode COM 10, the hold voltage waveforms to the common electrodes COM 4-9, and the non-select voltage waveforms to the common electrodes COM 1-3. That is, in order to DDS drive the cholesteric liquid crystal device, a common driver IC used for the common electrodes is required to comprise a function to output four levels of voltage waveforms such as the reset, select, hold, and non-select voltage waveforms.

SID'97 Digest, 899 (1997) discloses voltage waveforms to be applied to common electrodes and segment electrodes in a cholesteric liquid display device for a DDS drive, the waveforms thereof are shown in FIGS. 3A and 3B.

In FIG. 3A, on upper column there are shown the voltage waveforms applied to common electrodes, on left column the voltage waveforms applied to segment electrodes, on middle column and lower column except the left column synthesized voltage waveforms applied between the common electrodes and the segment electrodes, the synthesized voltage waveform being the difference between the voltage waveform applied to the common electrode and that applied to the segment electrode.

FIG. 3B shows the voltage waveforms applied to the common electrode, and the voltage waveforms being arranged in a vertical direction common to a time axis for comparison. In FIGS. 3A and 3B, each of the reset, select, hold and non-select voltage waveforms includes four unit intervals (1)-(4). It is understood that four levels of voltages are required every unit interval.

In the DDS drive method, a driver IC is required in which four levels of voltages are always outputted at the same time every unit interval. A generalized driver IC used in a Super Twisted Nematic (STN) liquid crystal display device usually may output two levels of voltages at the same time. Therefore, a dedicated driver IC is required to be prepared for the DDS drive.

It is reported in SID'02 Digest, 546(2002) that the number of levels of voltages outputted at the same time may be decreased. Voltage waveforms applied to a common electrode and segment electrode in SID'02 Digest are shown in FIGS. 4A and 4B. It is appreciated that the number of levels of voltages applied to the common electrode is decreased to three. Therefore, the size of the driver IC may be decreased, resulting in the cost down thereof. As three levels of voltages are required during unit intervals (2)-(4), a dedicated driver IC for outputting three levels of voltages is still required.

In addition, Japanese patent publication No. 2001-228459 discloses a technique such that the output voltage of a driver for common electrodes is caused to be two levels of voltages. In this technique, however, three levels of voltages to common electrodes are required for writing in a cholesteric liquid crystal display device, and a voltage switching means is required to be provided to a driver for common electrodes. Also as a reset period of time is isolated from a select period of time, the number of common electrodes is limited for realizing a display which is easily visible.

### DISCLOSURE OF THE INVENTION

An object of the present invention is to provide a drive method in which the cost of a generalized driver IC for a DDS drive may be suppressed by determining a drive voltage waveform which permits the number of levels of an output voltage to be three or less.

Another object of the present invention is to provide a cholesteric liquid crystal display apparatus to realize the drive method described above.

A first aspect of the present invention is a method for driving a cholesteric liquid crystal display device in which a cholesteric liquid crystal is driven in a matrix manner by means of a plurality of common electrodes and segment electrodes, the common electrodes and segment electrodes being crossed oppositely. The method comprises the steps of: writing a display content to the cholesteric crystal by sequentially applying common electrode drive voltage waveforms from the common electrodes to the cholesteric liquid crystal display device, the common electrode drive voltage waveforms including a reset voltage waveform to cause the cholesteric liquid crystal to a homeotropic state, a select voltage waveform to select a final alignment state of the cholesteric liquid crystal, a hold voltage waveform to hold an alignment state selected by the select voltage waveform, and a non-select voltage waveform caused by a matrix drive; and applying segment electrode drive voltage waveforms from the segment electrodes to the cholesteric liquid crystal display device during the step of writing a display content, the segment electrode drive voltage waveforms including at least an ON voltage waveform for determining the final alignment state of the cholesteric liquid crystal as a planar alignment state, and an OFF voltage waveform for determining the final alignment state as a focal conic state; wherein the common electrode drive voltage waveforms are formed so that there is no period of time during which the same voltage is applied to all common electrodes at the same time in a period of time from the application of the hold voltage waveform to the first common electrode to the application of the reset voltage waveform to the last common electrodes, during the step of writing a display content, and the segment electrode drive voltage waveforms are formed so that there is a period of time during which the same voltage is applied to all segment electrodes at the same time during the step of writing a display content.

A second aspect of the present invention is a cholesteric liquid crystal display apparatus. The apparatus comprises: a liquid crystal display device in which a plurality of picture elements are formed at portions crossed by a plurality of common electrode and a plurality of segment electrodes, a common driver for writing a display content to the picture elements by sequentially applying drive voltage waveforms from the common electrodes to the cholesteric liquid crystal display device, the drive voltage waveforms including a reset voltage waveform to cause the cholesteric liquid crystal to a homeotropic state, a select voltage waveform to select a final alignment state of the cholesteric liquid crystal, a hold voltage waveform to hold an alignment state selected by the select voltage waveform, and a non-select voltage waveform caused by a matrix drive; a segment driver for applying drive voltage waveforms from the segment electrodes to the cholesteric liquid crystal display device during the step of writing a display content, the drive voltage waveforms including at least an ON voltage waveform for determining the final alignment state of the cholesteric liquid crystal as a planar alignment state, and an OFF voltage waveform for determining the final alignment state as a focal conic state; and a controller for controlling the common driver and segment driver; wherein the controller controls the common and segment driver in such a way that each of the reset, select, hold, non-select, ON and OFF voltage waveforms has the same number of unit intervals, each of the reset, select, hold, non-select voltage waveforms has two levels of voltages in the same unit interval, and each of the ON and OFF voltage waveforms has two or less levels of voltages in the same unit interval.

### BRIEF DESCRIPTION OF DRAWINGS

FIG. 1 shows a drive voltage waveform in the DDS method.

FIG. 2 shows a timing of the voltages applied to common electrodes.

FIGS. 3A and 3B show the voltage waveforms applied to the common and segment electrodes in the cholesteric liquid crystal display device for DDS drive.

FIGS. 4A and 4B show the voltage waveforms applied to the common and segment electrodes in the cholesteric liquid crystal display device for DDS drive.

FIG. 5 shows a schematic diagram of the structure of cholesteric liquid crystal display apparatus in accordance with the present invention.

FIG. 6 shows a schematic view of a cholesteric liquid crystal display device used in a cholesteric liquid crystal display apparatus in accordance with the present invention.

FIGS. 7A and 7B show a reset, select, hold, and non-select voltage waveforms applied to common electrodes, and an ON and OFF voltage waveforms applied to segment electrodes in the embodiment 1.

FIGS. 8A, 8B and 8C show an example of voltage waveforms applied to each common electrode and segment electrode in order to drive a cholesteric liquid crystal display device in a matrix manner by the voltage waveforms shown in FIGS. 7A and 7B.

FIG. 9 shows the voltage waveforms to be applied to respective picture elements shown in FIG. 8A.

FIG. 10 show a schematic view of the voltage waveforms applied to the liquid crystal display device.

FIGS. 11A and 12B show DDS drive voltage waveforms to allow a gray scale display.

FIG. 12 shows the voltage waveforms.

FIGS. 13A and 13B show the voltage waveforms.

FIGS. 14A and 14B show the voltage waveforms.

FIGS. 15A and 15B show the voltage waveforms.

FIGS. 16a and 16B show the voltage waveforms.

FIGS. 17A and 17B show the voltage waveforms.

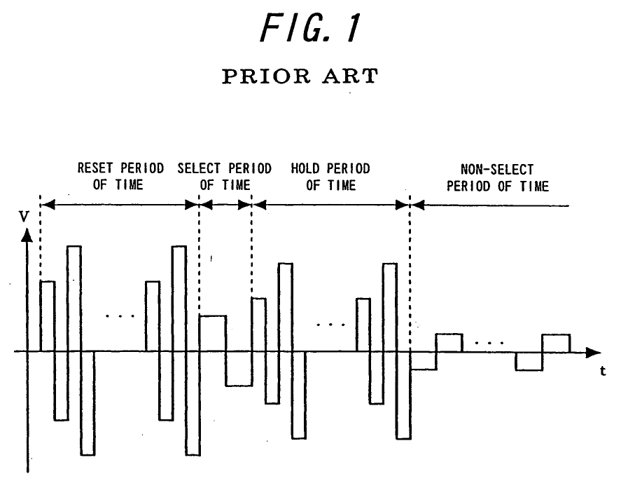

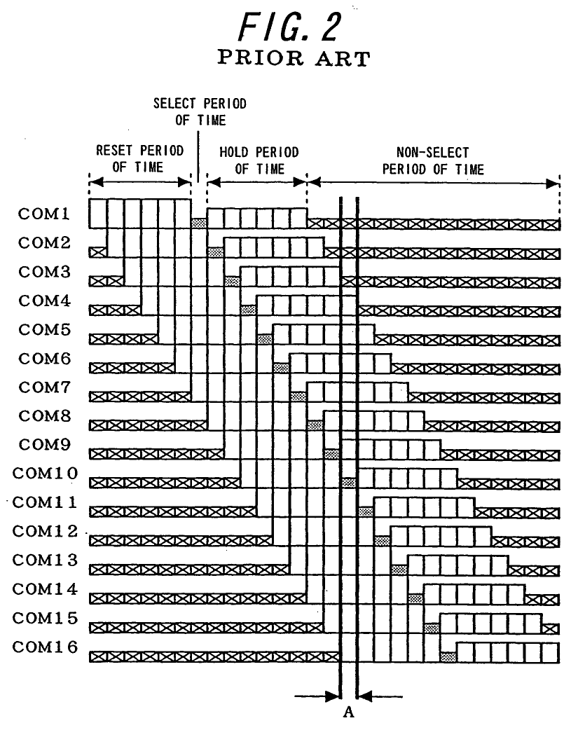

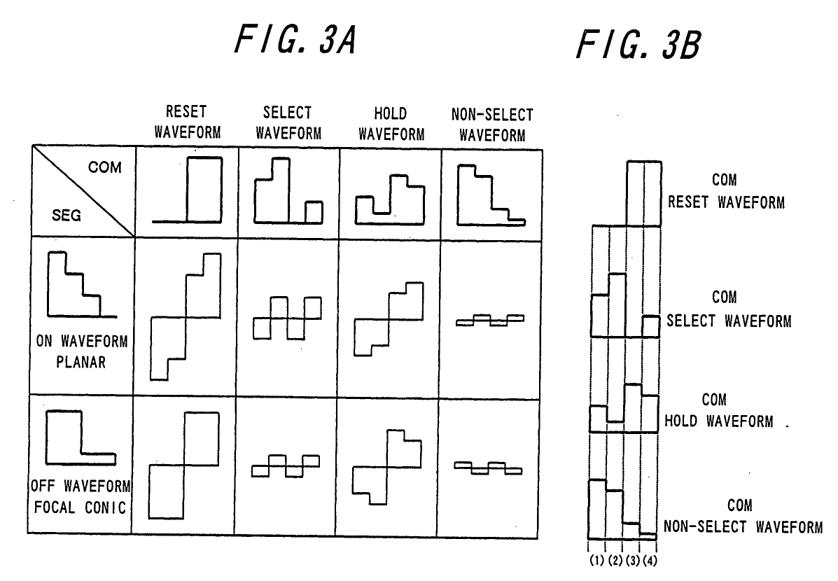

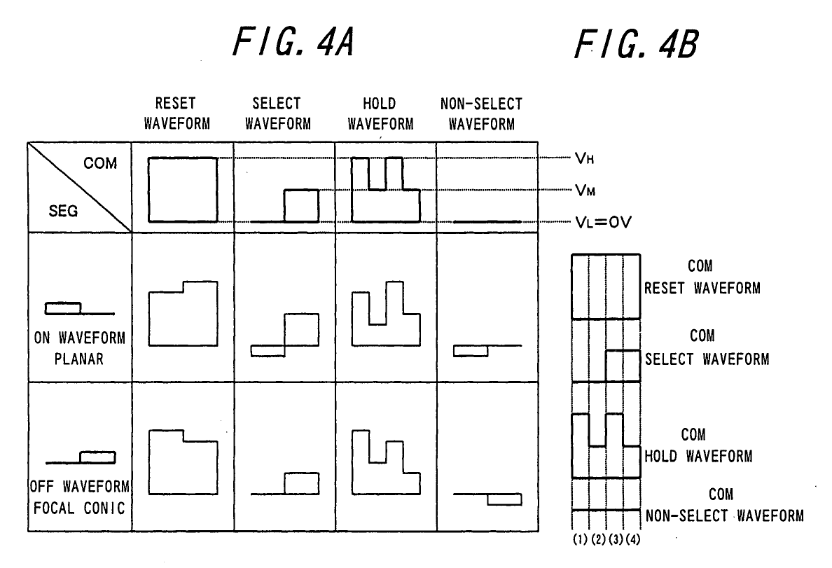

### BEST MODE FOR CARRYING OUT THE INVENTION

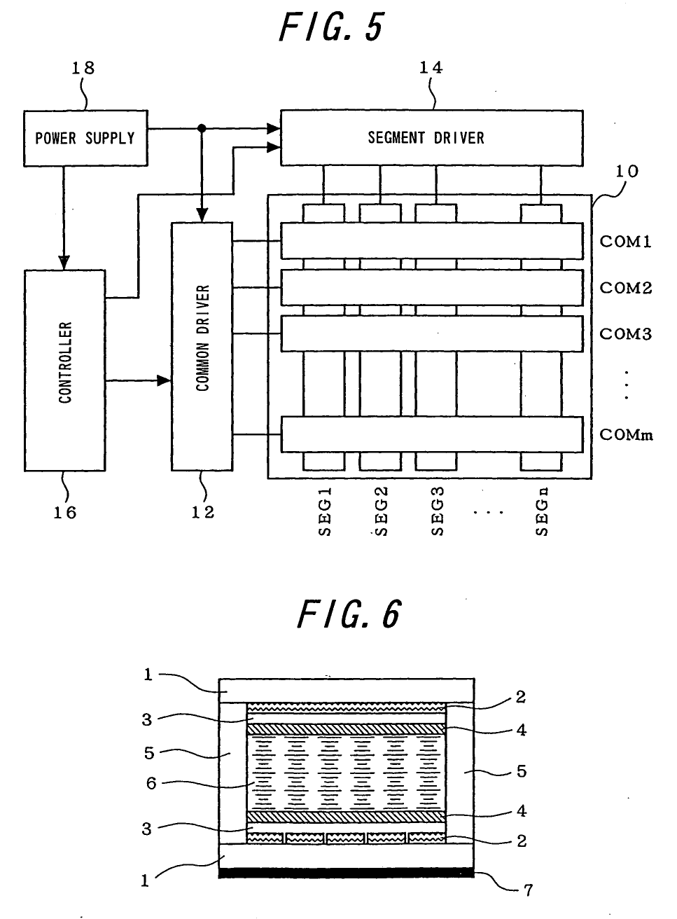

FIG. 5 is a schematic diagram of the structure of a cholesteric liquid crystal display apparatus in accordance with the present invention. The cholesteric liquid crystal display apparatus comprises a cholesteric liquid crystal display device 10 driven in matrix by means of a plurality of common electrodes COM1, COM2, . . . and a plurality of segment electrodes SEG1, SEG2 . . . , both of them being oppositely crossed, and a mechanism for writing a display content in accordance with a method of the present invention. The mechanism comprises a common driver 12, a segment drive 14, a controller 16, and a power supply 18.

The common electrodes of the cholesteric liquid crystal display device 10 are connected to the outputs of the common driver 12, and the segment electrodes to the outputs of the segment driver 14. Voltages are applied from the common driver 12 to the common electrodes COM1, COM2, . . . and from the segment driver 14 to the segment electrodes SEG1, SEG2 . . . , respectively, based on the instruction from the controller 16. The difference between the voltage of a common electrode and the voltage of a segment electrode is applied to a picture element of the liquid crystal display device 10.

In the present invention, the maximum voltage to be applied to common electrodes and segment electrode is selected to be 42 volts. The larger the voltage applied to the common electrode and segment electrode, the easier various cholesteric liquid crystal devices are applicable. However, the maximum voltage is enough to be 42 volts or less considering totally a drive method of the present invention, the facility in fabrication of a liquid crystal display device, an optical characteristic, and the facility in availability of a liquid crystal.

FIG. 6 shows a schematic view of a cholesteric liquid crystal display device 10 used in a cholesteric liquid crystal display apparatus in accordance with the present invention. In FIG. 6, the substrate 1 consists of quartz glass, soda-lime glass having a film for preventing the dissolution of alkali ion, a plastic film such as polyether sulfon and polyethylene terephthalate, or a plastic substrate such as polycarbonate.

The electrode layer 2, the electric insulating film 3, and the alignment layer 4 are stacked in this order on the substrate 1, and then the electrode layer 2 is patterned to form a plurality of linear electrodes. In this manner, two transparent substrates are fabricated. These two transparent are laminated to each other by the main seal 5 to fill the cholesteric liquid crystal material 6 in a space enclosed by the main seal.

While ITO (Indium Tin Oxide) is preferable for the material of the electrode 2, conductive metal oxide such as SnO₂ and conductive material such as conductive resin like polypyrrole and polyaniline may also be used.

Insulating material such as SiO₂ and TiO₂ is preferable for the electrical insulating film 3 which is provided for preventing a short circuit between the opposite electrodes, but it is not necessary required.

A horizontal or vertical alignment layer may be used to the alignment layer 4. While polyimide resin is preferable for the alignment layer 4, surface modifier or resin containing silicon, fluorine or nitrogen may be used.

The cholesteric liquid crystal 6 preferably consists of nematic liquid crystal having a positive dielectric anisotropy and 10-50 weight % of chiral material. As the nematic liquid crystal to be used, one is preferable in which a dielectric anisotropy Δε is 8 or more and the viscosity is 60 mPa·S in a room temperature. In a high viscosity liquid crystal, a select period of time is required to be longer in order to obtain a display having enough contrast. If the viscosity of a liquid crystal is larger than approximately 60 mPa·S in a room temperature, a select period of time become long, which is not preferable. On the other hand, the smaller a dielectric anisotropy Δε of a liquid crystal, the higher drive voltage is required. If Δε is smaller than approximately 8 in a room temperature, a high drive voltage is selected, which is not preferable. Examples of a nematic liquid crystal are cyanobiphenyl-type, phenylcychohexyl-type, phenylbenzonate-type, cyclohexylbenzoate-type, and tolane-type, but are not limited thereto.

Cholesteric liquid crystal may be dispersed in polymer matrix or capsulated. The selected reflective wavelength of a cholesteric liquid crystal may be not only in visible area but also infrared area.

The distance between electrodes of a cholesteric liquid crystal layer is preferably 6.0 μm or less for the case of visible light reflection. The distance larger than 6.0 μm is not preferable due to the cloudiness of the liquid crystal in a focal conic state.

The light absorbing film 7 may be provided on the side opposite to the viewing side. The color of the light absorbing film is preferably black or blue, but is not limited thereto. An optical film such as a reflection film, deflection film, and phase difference film may be attached in place of the light absorbing film 7.

On the viewing surface, a deflection film, a phase difference film, or an optical film having a function of ultraviolet shielding may be attached.

The present invention will now be described with reference to embodiments and comparison examples.

### Embodiment 1

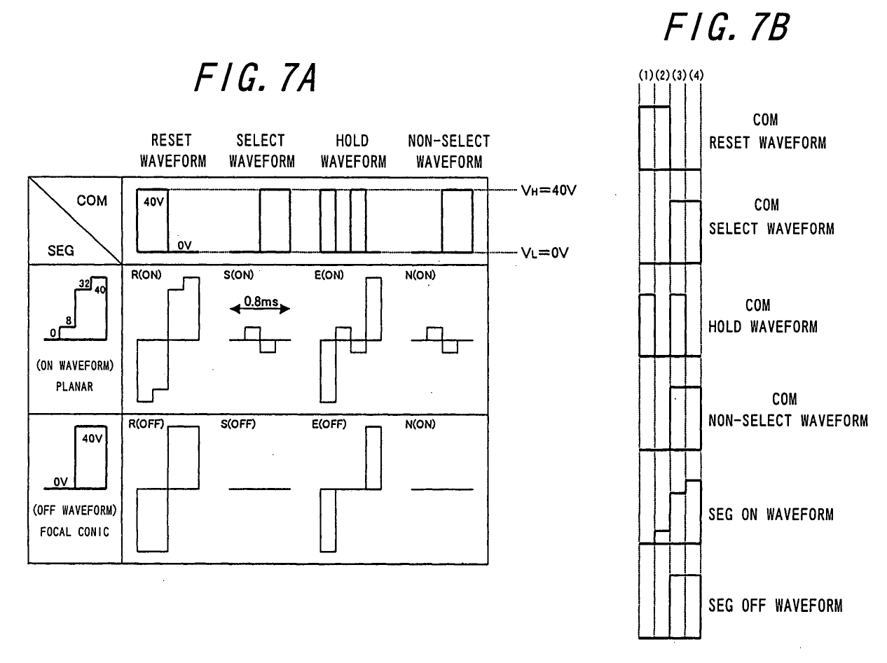

In FIGS. 7A and 7B, there are shown a reset, select, hold, and non-select voltage waveforms applied to common electrodes, and an ON and OFF voltage waveforms applied to segment electrodes. The shape of the OFF voltage waveform and that of each of the non-select and select voltage waveforms are the same. The maximum voltages of the reset, select, hold, and non-select voltage waveforms are 40 volts, respectively.

In FIG. 7B, the reset, select, hold, and non-select voltage waveforms have the same width (0.8 msec), and each has four unit intervals (1)-(4), the voltages in each of the unit intervals (1)-(4) including two levels of voltages, i.e., 0 and 40 volts. Therefore, a driver which outputs two levels of voltages may be used for the common driver 12.

The ON and OFF voltage waveforms applied to the segment electrodes have the same width as that of each of voltage waveforms applied to the common electrodes, and each has four unit intervals (1)-(4). The ON and OFF voltage waveforms have both 0 volts in the unit interval (1), 8 volts and 0 volts in the unit interval (2), 32 volts and 40 volts in the unit interval (3), and both 40 volts in the unit interval (4). In this manner, the voltage waveforms applied to the segment electrodes have four levels of voltages. The voltage waveforms in the unit intervals (2) and (3) have two levels of voltage, respectively, so that a driver which outputs two or less levels of voltages may be used for the segment driver 14.

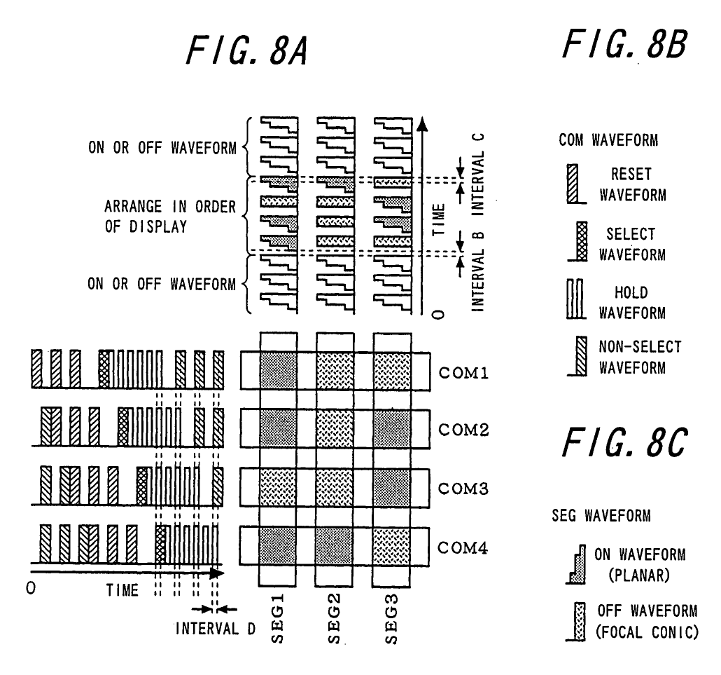

In FIGS. 8A, 8B and 8C, there are shown an example of DDS drive voltage waveforms applied to each common electrode and segment electrode in order to drive a cholesteric liquid crystal display device in a matrix manner by the voltage waveforms shown in FIGS. 7A and 7B. In FIG. 8A, there is shown a liquid crystal display device 10 having a matrix structure of four common electrodes and three segment electrodes for the simplicity of the drawing. The numbers of common and segment electrodes are not limited because a cholesteric liquid crystal has a memory characteristic.

A reset, hold, and non-selected period of time are integrally multiplied by a period of time of the reset, hold, and non-select voltage waveform, respectively. Therefore, the reset, hold, and non-select voltage waveform shown in FIG. 7A are repeated integral times in the reset, hold, and non-select period of time, respectively. In FIG. 8A, the reset voltage waveform is repeated three times in a reset period of time, the hold voltage waveform three times in a hold period of time, and the non-select voltage waveform three times in a non-select period of time. However, there is a case such that a period of time during which the reset voltage waveform is repeated three times is shortage because a alignment state of liquid crystal is to be reset to a homeotropic alignment state. While the reset period of time may be selected to be longer for permitting to be reset at a lower voltage, the reset period of time is usually selected to be 5-100 msec. The hold period of time is preferably selected to be a period of time during which a hold voltage waveform applied to the common electrodes is repeated 2-100 times. A period of time during which a hold voltage waveform is repeated 5-50 times is more preferable. A period of time for one hold voltage waveform is led to a high focal conic reflectance, and a period of time for 100 or more hold voltage waveforms is led to a low planar reflectance, both thereof being not preferable.

As shown in FIG. 8A, voltages applied to the common electrodes are two levels of voltages (0 and 40 volts) through all common electrodes and all periods of time, because all of the reset, select, hold and non-select voltage waveforms applied to common electrodes shown in FIG. 7A are composed of two levels of voltages.

In the present embodiment, while the same voltage is applied to all common electrodes during D interval at the same time as shown in FIG. 8A, it is intended that a period of time during which the same voltage is applied to all common electrodes is not included in a period of time from the application of a hold voltage waveform to the first common electrode to the application of a reset voltage waveform to the last common electrodes. This is based on the fact that if a period of time during which the same voltage is applied to all common electrodes is present, a low voltage interval is caused in a reset period of time, or a high voltage interval is caused in a non-select period of time, resulting in that a higher voltage to be applied to common and segment electrodes is required in order to cause a cholesteric liquid crystal to a homeotropic alignment state during a reset period of time, and that the reflectance of a picture element caused to a planar alignment state after a hold period of time is decreased by a voltage outputted during a non-select period of time.

In order that the same voltage is not applied to all common electrodes in a period of time from the application of a hold voltage waveform to the first common electrode to the application of a reset voltage waveform to the last common electrodes, each of the reset, select, hold and non-select voltage waveforms applied to common electrodes shown in FIG. 7A is selected so that all thereof have not the same voltage every unit interval (1)-(4).

On the other hand, unit intervals such as intervals B and C shown in FIG. 8A are provided in which the same voltage is applied to all segment electrodes at the same time. The interval B corresponds to the unit interval (1) including respective voltage waveforms applied to segment electrodes shown in FIG. 7B, the voltage of 0 volts being applied to all segment electrodes. The interval C corresponds to the unit interval (4) in which the voltage of 40 volts is applied to all segment electrodes.

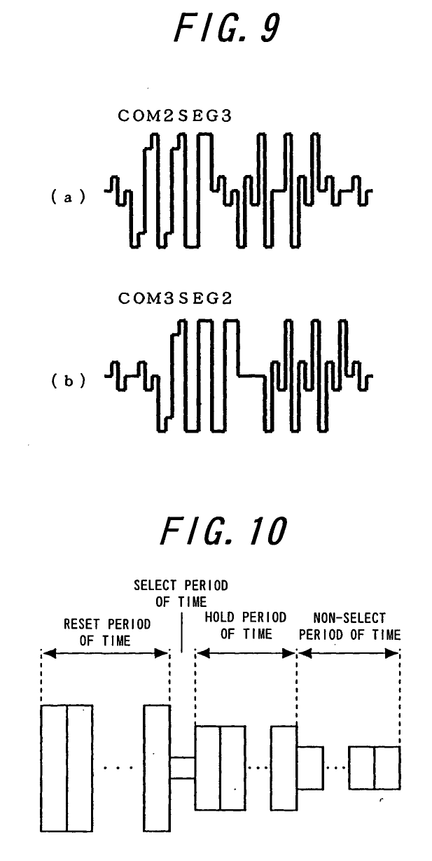

The difference between a voltage waveform to a common electrode a voltage waveform to a segment electrode is applied to a picture element of the liquid crystal display device. As an example, the voltage waveforms to be applied to respective picture elements (COM2, SEG3) and (COM3, SEG2) shown in FIG. 8A are illustrated in FIG. 9. The waveform (a) is one applied to the picture element (COM2, SEG3), and the waveform (b) to the picture element (COM3, SEG2).

The liquid crystal display device having a 4×3 matrix structure has been described above for the simplicity of explanation. The concrete embodiment will now be described in detail.

The cholesteric liquid crystal display device 10 was fabricated by using liquid crystal material made of the mixture of 0.7 grams of nematic liquid crystal material RPD-84202 (viscosity 30 mPa·S, Δε≅10) commercially available by DAINIPPON INK AND CHEMICALS INCORPORATED, 0.2 grams of chiral material CB-15 commercially available by Merk & Co., Inc., and 0.1 grams of chiral material CNL-617R commercially available by ASAHI DENKA Co., Ltd. The thickness of the liquid crystal layer was 4.5 μm.

To the fabricated cholesteric liquid crystal display device, applied were DDS drive voltage waveforms shown in Table 1 formed by the waveforms in FIG. 7A.

TABLE 1

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(ON) | 20 | S(ON) | 1 | E(ON) | 5 | N(ON) | 10 | 15.0% |
| A | | | | | | | | | |
| Waveform | R(ON) | 20 | S(ON) | 1 | E(ON) | 5 | N(ON) | 630 | 15.0% |
| B | | | | | | | | | |
| Waveform | R(ON) | 20 | S(ON) | 1 | E(OFF) | 5 | N(ON) | 10 | 15.0% |
| C | | | | | | | | | |
| Waveform | R(ON) | 20 | S(ON) | 1 | E(OFF) | 5 | N(ON) | 630 | 15.0% |
| D | | | | | | | | | |
| Waveform | R(ON) | 20 | S(OFF) | 1 | E(ON) | 5 | N(ON) | 10 | 2.5% |
| E | | | | | | | | | |
| Waveform | R(ON) | 20 | S(OFF) | 1 | E(ON) | 5 | N(ON) | 630 | 2.5% |
| F | | | | | | | | | |
| Waveform | R(ON) | 20 | S(OFF) | 1 | E(OFF) | 5 | N(ON) | 10 | 2.5% |
| G | | | | | | | | | |
| Waveform | R(ON) | 20 | S(OFF) | 1 | E(OFF) | 5 | N(ON) | 630 | 2.5% |
| H | | | | | | | | | |

In FIG. 10, the condition is illustrated in which the reset, select, hold, and non-select voltage waveforms are applied repeatedly plural times in the reset, select, hold, and non-select period of time, respectively. In Table 1, there are shown the repetition times of respective waveforms A-H in each period of time, and the condition (ON, OFF) in which ON and OFF voltage waveform are applied to segment electrodes.

The DDS drive voltage waveforms described above are formed by controlling the common driver 12 and segment driver 14 through the instruction from the controller 16 in FIG. 5.

In Table 1, there is shown the result (luminous reflectance) of the display of the liquid crystal display device 10 after the DDS drive voltage waveforms were applied thereto. For any applied voltage waveforms A-H, the cholesteric liquid crystal was caused to a planar alignment state when the ON voltage waveform was applied during the select voltage waveform was applied, and a focal conic state when the OFF voltage waveform was applied. The luminous reflectance in a planar state was approximately 15%, the luminous reflectance in a focal conic state was approximately 2.5%, and the contrast was approximately 6.

According to the present embodiment, the liquid crystal display device could be driven in a good contrast by using the voltage waveforms shown in FIG. 7A. It is appreciated that a driver outputting two levels of voltages may be used as the common driver 12, and a driver outputting two or less levels of voltages may be used as the segment driver 14.

Also in the present embodiment, the maximum voltages of the reset and hold voltage waveforms are the same, so that a voltage switching means used in a conventional technique is unnecessary in the common electrode side, and the voltages outputted from the driver for common electrodes may be two levels of voltages.

### Embodiment 2

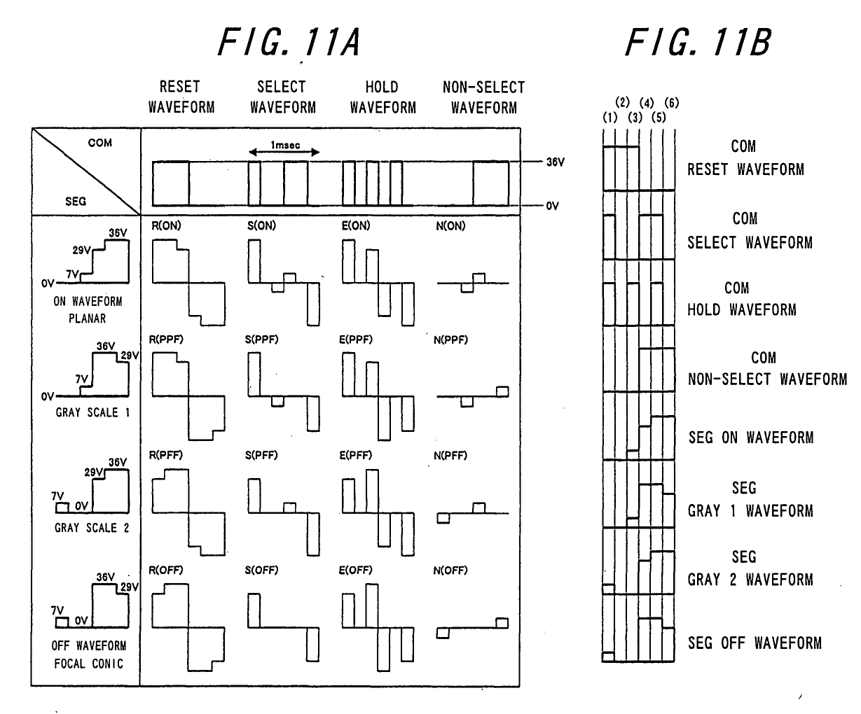

In the present embodiment, the voltage waveforms shown in FIGS. 11A and 11B are used. All voltage waveforms applied to common electrodes and all voltage waveforms applied to segment electrodes have the same width (1 msec) and include six unit intervals (1)-(6).

The voltage waveforms for common electrodes have two levels of voltages (0 and 36 volts) every unit interval (1)-(6). As shown in FIG. 11B, there is no unit interval in which all of the reset, select, hold, and non-select voltage waveforms have 0 volts or 36 volts. Therefore, in the cholesteric liquid crystal display apparatus, there is no period of time during which the same voltage is applied to all common electrodes in a period of time from the application of a hold voltage waveform to the first common electrode to the application of a reset voltage waveform to the last common electrodes. A driver outputting two levels of voltages may be used as the common driver 12 in the present embodiment.

While the voltage waveforms applied to segment electrodes are an ON voltage waveform, OFF voltage waveform, gray scale step 1 (PPF) voltage waveform, gray scale step 2 (PFF) voltage waveform, all thereof being composed of four levels of voltages (V4=0 volts, V3=7 volts, V2=29 volts, V1=36 volts), all of the waveforms have V4 (0 volts) respectively in the unit interval (2), and V1 (36 volts) in the unit interval (5). Therefore, in the cholesteric liquid crystal display apparatus, a period of time during which V4 (0 volts) is applied to all segment electrodes, and a period of time during which V1 (36 volts) is applied to all segment electrodes are included in a writing step of display content. As the unit intervals (1) and (3) have two levels of voltage, i.e., V4 (0 volts) and V3 (7 volts), and the unit intervals (4) and (6) have two levels of voltage, i.e., V2 (29 volts) and V1 (36 volts), a driver outputting two or less levels of voltages may be used as the segment driver 14.

The DDS drive voltage waveforms formed by the voltage waveforms described above and applied to the cholesteric liquid crystal display device as shown in FIG. 10, and the measured results of luminous reflectance are shown in Table 2.

TABLE 2

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(OFF) | 20 | S(ON) | 1 | E(ON) | 5 | N(ON) | 630 | 15.0% |
| A | | | | | | | | | |
| Waveform | R(OFF) | 20 | S(ON) | 1 | E(OFF) | 5 | N(ON) | 630 | 15.0% |
| B | | | | | | | | | |
| Waveform | R(OFF) | 20 | S(OFF) | 1 | E(ON) | 5 | N(ON) | 630 | 2.5% |
| C | | | | | | | | | |
| Waveform | R(OFF) | 20 | S(OFF) | 1 | E(OFF) | 5 | N(ON) | 630 | 2.5% |
| D | | | | | | | | | |
| Waveform | R(OFF) | 20 | S(PPF) | 1 | E(OFF) | 5 | N(ON) | 630 | 11.5% |
| E | | | | | | | | | |
| Waveform | R(OFF) | 20 | S(FFP) | 1 | E(OFF) | 5 | N(ON) | 630 | 8.0% |
| F | | | | | | | | | |

For any applied voltage waveforms A-F, the cholesteric liquid crystal was caused to a planar alignment state when the ON voltage waveform was applied during the select voltage waveform was applied, a focal conic state when the OFF voltage waveform was applied, and an intermediate state between a planar alignment state and a focal conic alignment state (PPF and PFF) when the gray scale step 1 and 2 voltage waveforms were applied. The luminous reflectance in a planar state was approximately 15%, the luminous reflectance in a focal conic state was approximately 11.5%, and the luminous reflectance in the intermediate states were approximately 11.5% and 8.0%.

According to the present embodiment, a gray scale display may be realized by means of the common driver 12 outputting two levels of voltages and the segment driver 14 outputting two or less levels of voltages by providing voltage waveforms applied to segment electrodes with low voltage unit intervals having V3 and V4 respectively and high voltage unit intervals having V1 and V2 respectively to control the output timing of V3 in the low voltage unit interval and the output timing of V2 in the high voltage unit interval.

### COMPARISON EXAMPLE 1

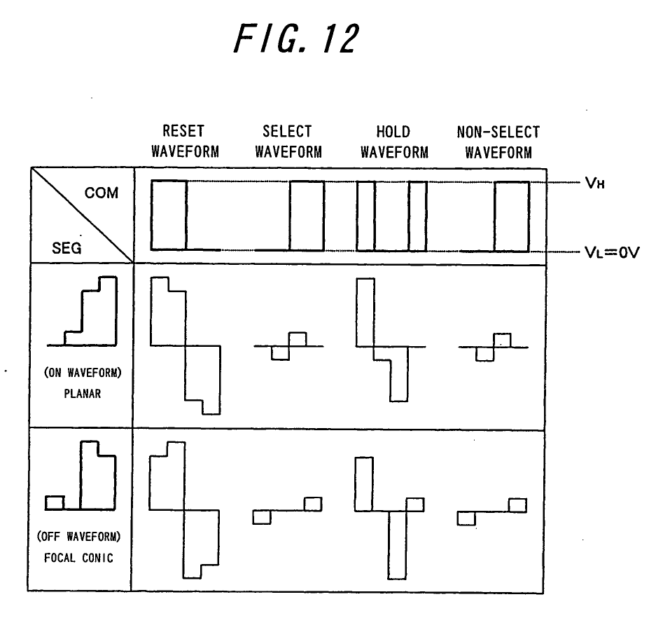

In order to determine the effects of the embodiments 1 and 2, the DDS drive voltage waveforms using the voltage waveforms in FIG. 12 were applied to the liquid crystal display device 10 to observe the display state.

In FIG. 12, the voltage waveforms applied to common electrodes have two levels of voltages every unit interval. On the other hand, there is no unit interval having the same voltage for the voltage waveforms applied to segment electrodes. That is, in this cholesteric liquid crystal display apparatus, there is no period of time during which the same voltage is applied to all segment electrodes in the writing step of a display content.

While the voltage and width of each voltage waveform were caused to be variously changed for studying a display having a good contrast could not be realized. It is therefore appreciated that a unit interval having the same voltage is required for the voltage waveforms (ON and OFF voltage waveforms) applied to all segment electrodes of the cholesteric liquid crystal display device as in the embodiments 1 and 2 in order to obtain a display having a good contrast in the cholesteric liquid crystal display device.

### Embodiment 3

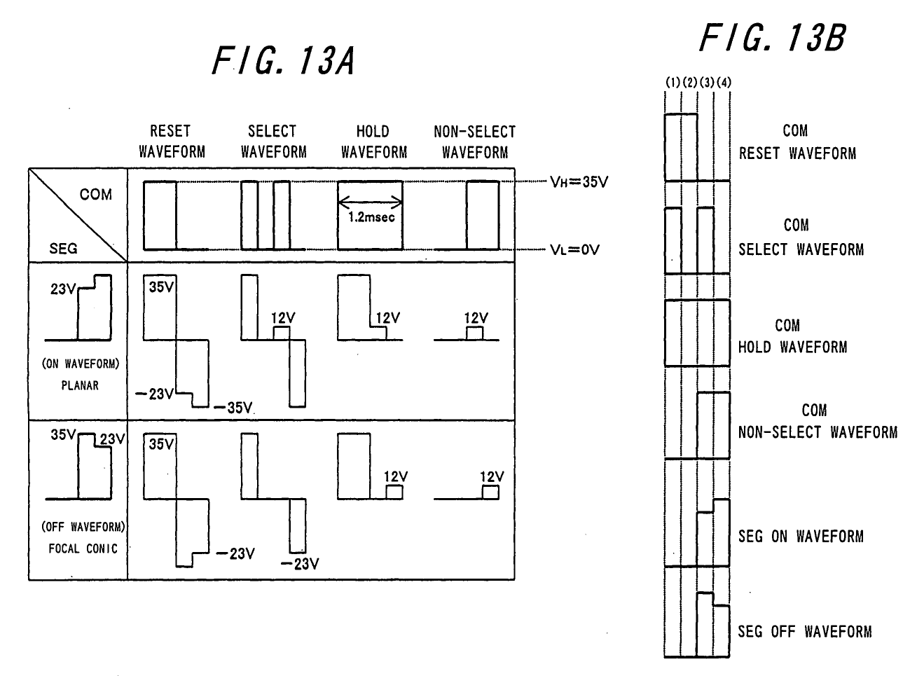

The cholesteric liquid crystal display device 10 having 100 common electrodes and 100 segment electrodes was fabricated in the same manner as in the embodiment 1. The cholesteric liquid crystal display device was provided on a cholesteric liquid crystal display apparatus and was driven by voltage waveforms shown in FIGS. 13A and 13B, in which all voltage waveforms applied to common electrodes and all voltage waveforms applied to segment electrodes have the same width (1.2 msec) and include four unit intervals (1)-(4).

The voltage waveforms applied common electrodes have two levels of voltages (35 and 0 volts). There is no unit interval in which all of the reset, select, hold, and non-select voltage waveforms have the same voltage, so that in the cholesteric liquid crystal display apparatus, there is no period of time during which the same voltage is applied to all common electrodes in a period of time from the application of a hold voltage waveform to the first common electrode to the application of a reset voltage waveform to the last common electrodes. A driver outputting two levels of voltages may be used as the common driver 12 in the present embodiment.

While the voltage waveforms applied to segment electrodes have three levels of voltages (V4=0 volts, V2=23 volts, V1=35 volts), both of ON and OFF voltage waveforms have V4 (0 volts) in the unit intervals (1) and (2). Therefore, in the cholesteric liquid crystal display apparatus, a period of time is included during which V4 (0 volts) is applied to all segment electrodes in a writing step of display content. As the unit intervals (3) and (4) have two levels of voltages, i.e., V1 (35 volts) and V2 (23 volts), a driver outputting two or less levels of voltages may be used as the segment driver 14.

The DDS drive voltage waveforms formed by the voltage waveforms described above and applied to the cholesteric liquid crystal display device as shown in FIG. 10 had a reset period of time 20 times the width of a reset voltage waveform, and a hold period of time 7 times the width of a hold voltage waveform.

A display having a good contrast was realized in the cholesteric liquid crystal display device 10. The time required for a total rewriting step was approximately 0.2 msec.

### Embodiment 4

The cholesteric liquid crystal display device 10 shown in FIG. 6 was fabricated by using liquid crystal material made of the mixture of 0.68 grams of nematic liquid crystal material NA-4320 XX (viscosity≅4 mPa·S, Δε≅10) commercially available by CHISSO CORPORATION, 0.22 grams of chiral material CB-15 commercially available by Merk & Co., Inc., and 0.1 grams of chiral material CNL-617R commercially available by ASAHI DENKA Co., Ltd. The thickness of the liquid crystal layer was 4.0 μm.

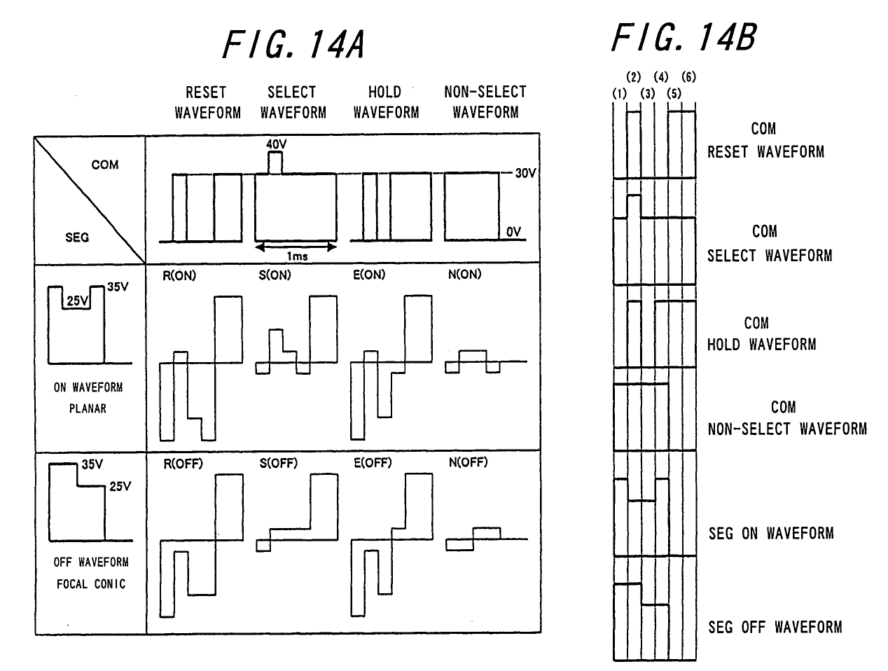

To the fabricated cholesteric liquid crystal display device, applied were DDS drive voltage waveforms shown in FIGS. 14A and 14B to observe a display.

All voltage waveforms applied to common electrodes and all voltage waveforms applied to segment electrodes shown in FIGS. 14A and 14B have the same width (1 msec) and include six unit intervals (1)-(6). While the voltage waveforms applied to common electrodes have three levels of voltages (Vh=40 volts, Vm=30 volts, V1=0 volts), the unit interval (2) has two levels of voltages, i.e., Vh and Vm, other unit intervals have two levels of voltages, i.e., Vm and V1. A driver outputting two levels of voltages, therefore, may be used as the common driver 12. There is no unit interval in which all of the reset, select, hold, and non-select voltage waveforms have the same voltage, so that in the cholesteric liquid crystal display apparatus, there is no period of time during which the same voltage is applied to all common electrodes in a period of time from the application of a hold voltage waveform to the first common electrode to the application of a reset voltage waveform to the last common electrodes.

While the voltage waveforms applied to segment electrodes have three levels of voltages (V4=0 volts, V2=23 volts, V1=35 volts), both of ON and OFF voltage waveforms in the unit interval (1) have V1, both of ON and OFF voltage waveforms in the unit interval (3) have V2, both of ON and OFF voltage waveforms in the unit intervals (5) and (6) have V4. Therefore, in the cholesteric liquid crystal display apparatus, a period of time during which V4 (0 volts) is applied to all segment electrodes, a period of time during which V2 (25 volts) is applied to all segment electrodes, and a period of time during which V1 (35 volts) is applied to all segment electrodes are included in a writing step of display content. As the unit intervals (2) and (4) have two levels of voltage, i.e., V1 (35 volts) and V2 (25 volts), a driver outputting two or less levels of voltages may be used as the segment driver 14.

The DDS drive voltage waveforms formed by the voltage waveforms described above and applied to the cholesteric liquid crystal display device as shown in FIG. 10, and the measured results of luminous reflectance are shown in Table 3.

TABLE 3

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(OFF) | 20 | S(ON) | 1 | E(ON) | 10 | N(ON) | 630 | 15.0% |
| A | | | | | | | | | |
| Waveform | R(OFF) | 20 | S(ON) | 1 | E(OFF) | 10 | N(ON) | 630 | 15.0% |
| B | | | | | | | | | |
| Waveform | R(OFF) | 20 | S(OFF) | 1 | E(ON) | 10 | N(ON) | 630 | 2.5% |
| C | | | | | | | | | |
| Waveform | R(OFF) | 20 | S(OFF) | 1 | E(OFF) | 10 | N(ON) | 630 | 2.5% |
| D | | | | | | | | | |

For any applied voltage waveforms, the cholesteric liquid crystal was caused to a planar alignment state when the ON voltage waveform was applied during the select voltage waveform was applied, and a focal conic state when the OFF voltage waveform was applied. The luminous reflectance in a planar state was approximately 15%, the luminous reflectance in a focal conic state was approximately 2.5%, and the contrast was approximately 6.

### Embodiment 5

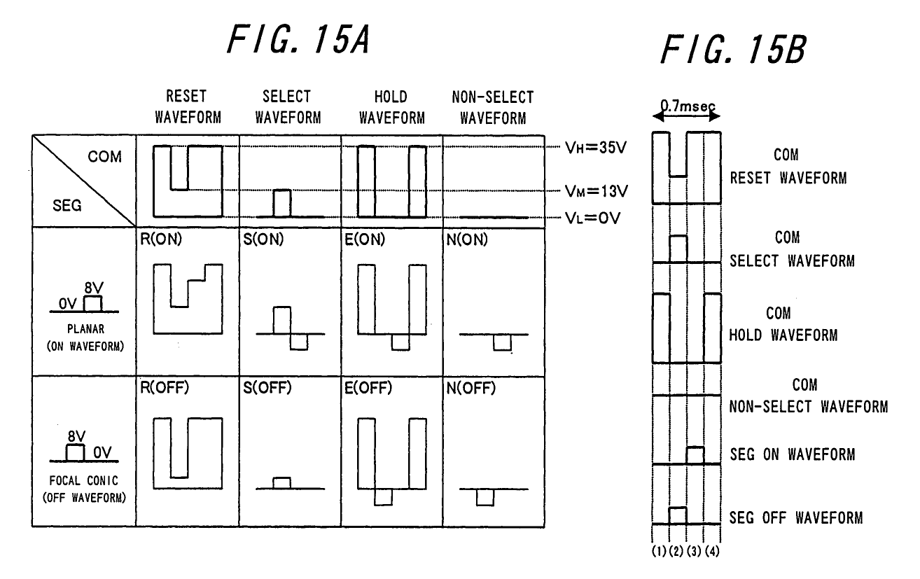

DDS drive voltage waveforms shown in FIGS. 15A and 15B were applied to the cholesteric liquid crystal display device 10 in the embodiment 1 to measure a luminous reflectance.

All voltage waveforms applied to common electrodes and all voltage waveforms applied to segment electrodes shown in FIGS. 15A and 15B have the same width (0.7 msec) and include four unit intervals (1)-(4).

While the voltage waveforms applied to common electrodes have three levels of voltages (Vh=35 volts, Vm=13 volts, V1=0 volts), the unit interval (2) has two levels of voltages, i.e., Vm and V1, other unit intervals have two levels of voltages, i.e., Vh and V1. A driver outputting two levels of voltages, therefore, may be used as the common driver 12. There is no unit interval in which all of the reset, select, hold, and non-select voltage waveforms have the same voltage, so that in the cholesteric liquid crystal display apparatus, there is no period of time during which the same voltage is applied to all common electrodes in a period of time from the application of a hold voltage waveform to the first common electrode to the application of a reset voltage waveform to the last common electrodes.

While the voltage waveforms applied to segment electrodes have two levels of voltages (0 volts and 8 volts), both of ON and OFF voltage waveforms in the unit intervals (1) and (4) have 0 volts. Therefore, in the cholesteric liquid crystal display apparatus, a period of time during which 0 volts is applied to all segment electrodes is included in a writing step of display content. Therefore, a driver outputting two or less levels of voltages may be used as the segment driver 14.

The DDS drive voltage waveforms formed by the voltage waveforms described above and applied to the cholesteric liquid crystal display device as shown in FIG. 10, and the measured results of luminous reflectance are shown in Table 4. A display of ON, OFF could be realized.

TABLE 4

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(OFF) | 20 | S(ON) | 1 | E(OFF) | 20 | N(ON) | 630 | 15.0% |
| A | | | | | | | | | |
| Waveform | R(OFF) | 20 | S(OFF) | 1 | E(OFF) | 20 | N(ON) | 630 | 2.5% |
| B | | | | | | | | | |

### Embodiment 6

The cholesteric liquid crystal display device 10 shown in FIG. 6 was fabricated by using liquid crystal material made of the mixture of 0.68 grams of nematic liquid crystal material MLC-6646-000 (viscosity≅50 mPa·S, Δε≅20) commercially available by Merk & Co., Inc., 0.22 grams of chiral material CB-15 commercially available by Merk & Co., Inc., and 0.1 grams of chiral material CNL-617R commercially available by ASAHI DENKA Co., Ltd. The thickness of the liquid crystal layer was 5.5 μm.

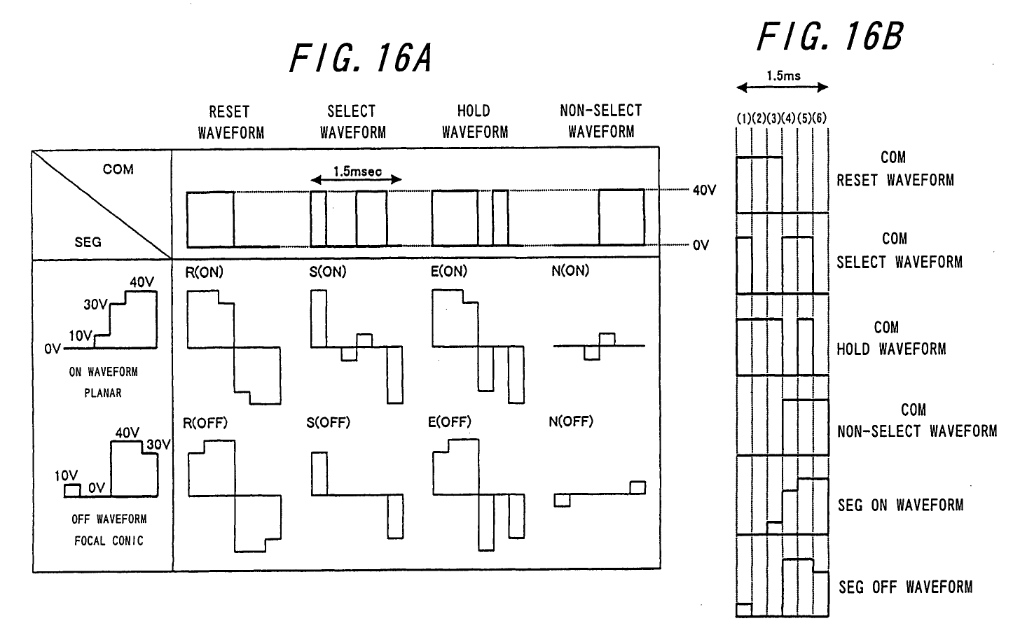

To the fabricated cholesteric liquid crystal display device, applied were DDS drive voltage waveforms shown in FIGS. 16A and 16B to observe a display.

All voltage waveforms applied to common electrodes and all voltage waveforms applied to segment electrodes shown in FIGS. 16A and 16B have the same width (1.5 msec) and include six unit intervals (1)-(6).

The voltage waveforms applied common electrodes have two levels of voltages (40 and 0 volts). There is no unit interval in which all of the reset, select, hold, and non-select voltage waveforms have the same voltage, so that in the cholesteric liquid crystal display apparatus, there is no period of time during which the same voltage is applied to all common electrodes in a period of time from the application of a hold voltage waveform to the first common electrode to the application of a reset voltage waveform to the last common electrodes. A driver outputting two levels of voltages may be used as the common driver 12 in the present embodiment.

While the voltage waveforms applied to segment electrodes have four levels of voltages (V4=0 volts, V3=10 volts, V2=30 volts, V1=40 volts), all of the waveforms have V4 (0 volts) respectively in the unit interval (2), and V1 (40 volts) in the unit interval (5). Therefore, in the cholesteric liquid crystal display apparatus, a period of time during which V4 (0 volts) is applied to all segment electrodes, and a period of time during which V1 (40 volts) is applied to all segment electrodes are included in a writing of display content. As the unit intervals (1) and (3) have two levels of voltages, i.e., V4 (0 volts) and V3 (10 volts), and the unit intervals (4) and (6) have two levels of voltages, i.e., V2 (30 volts) and V1 (40 volts), a driver outputting two or less levels of voltages may be used as the segment driver 14.

The DDS drive voltage waveforms formed by the voltage waveforms described above and applied to the cholesteric liquid crystal display device as shown in FIG. 10, and the measured results of luminous reflectance are shown in Table 5.

TABLE 5

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(OFF) | 20 | S(ON) | 1 | E(OFF) | 10 | N(ON) | 630 | 14.0% |
| A | | | | | | | | | |
| Waveform | R(OFF) | 20 | S(OFF) | 1 | E(OFF) | 10 | N(ON) | 630 | 2.0% |
| B | | | | | | | | | |

The cholesteric liquid crystal was caused to a planar alignment state when the ON voltage waveform was applied during the select voltage waveform was applied, and a focal conic state when the OFF voltage waveform was applied. The luminous reflectance in a planar state was approximately 14%, the luminous reflectance in a focal conic state was approximately 2%, and the contrast was approximately 7.

### Embodiment 7

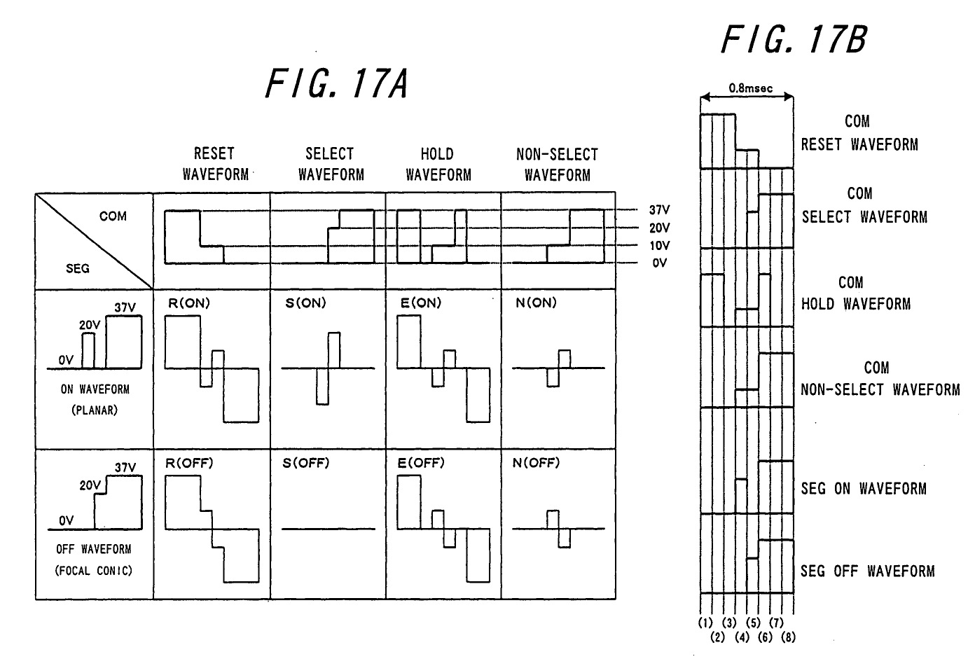

DDS drive voltage waveforms shown in FIGS. 17A and 17B were applied to the cholesteric liquid crystal display device 10 in the embodiment 1 to observe a display.

All voltage waveforms applied to common electrodes and all voltage waveforms applied to segment electrodes shown in FIGS. 17A and 17B have the same width (0.8 msec) and include eight unit intervals (1)-(8). While the voltage waveforms applied to common electrodes have four levels of voltages (Vh=37 volts, Vmh=20 volts, Vm1=10 volts, V1=0 volts), the unit interval (4) has two levels of voltages, i.e., Vm1 (10 volts) and V1 (0 volts), the unit interval (15) has two levels of voltages, i.e., Vmh (20 volts) and V1 (10 volts), and other unit intervals have two levels of voltages, i.e., Vh (37 volts) and V1 (0 volts). A driver outputting two levels of voltages may be used as the common driver 12. There is no unit interval in which all of the reset, select, hold, and non-select voltage waveforms have the same voltage, so that in the cholesteric liquid crystal display apparatus, there is no period of time during which the same voltage is applied to all common electrodes in a period of time from the application of a hold voltage waveform to the first common electrode to the application of a reset voltage waveform to the last common electrodes.

While the voltage waveforms applied to segment electrodes have three levels of voltages (V4=0 volts, V2=20 volts, V1=37 volts), both of ON and OFF voltage waveforms in the unit intervals (1), (2) and (3) have V4 (0 volts), both of ON and OFF voltage waveforms in the unit intervals (6), (7) and (8) have V1 (37 volts). Therefore, in the cholesteric liquid crystal display apparatus, a period of time during which V4 (0 volts) is applied to all segment electrodes, a period of time during which V1 (37 volts) is applied to all segment electrodes are included. As the unit intervals (4) and (5) have two levels of voltage, i.e., V2 (20 volts) and V4 (10 volts), a driver outputting two or less levels of voltages may be used as the segment driver 14.

The DDS drive voltage waveforms formed by the voltage waveforms described above and applied to the cholesteric liquid crystal display device as shown in FIG. 10, and the measured results of luminous reflectance are shown in Table 6. The cholesteric liquid crystal was caused to a planar alignment state when the ON voltage waveform was applied during the select voltage waveform was applied, and a focal conic state when the OFF voltage waveform was applied. The luminous reflectance in a planar state was approximately 15%, the luminous reflectance in a focal conic state was approximately 2.5%, and the contrast was approximately 6.

TABLE 6

| | | | | | | | Non-Select | | |
|---|---|---|---|---|---|---|---|---|---|
| | Reset Period | | Select Period | | Hold Period | | Period of | | |
| | of Time | | of Time | | of Time | | Time | | |
| | Wave- | | Wave- | | Wave- | | Wave- | | Luminous |
| | form | Times | form | Times | form | Times | form | Times | reflectance |
| Waveform | R(ON) | 50 | S(ON) | 1 | E(ON) | 30 | N(ON) | 630 | 15% |
| A | | | | | | | | | |
| Waveform | R(ON) | 50 | S(OFF) | 1 | E(ON) | 30 | N(ON) | 630 | 2.5% |
| B | | | | | | | | | |

### INDUSTRIAL APPLICABILITY

In accordance with the present invention, the output voltage of a driver for common electrodes may select to have two levels of voltages, and the output voltage of a driver for segment electrodes may select to have two or less levels of voltages. Therefore, the cost of a dedicated driver IC for a DDS drive may be suppressed. Furthermore, a cholesteric liquid crystal display apparatus may be realized in which a DDS drive using a generalized driver IC is possible.

1. A method for driving a cholesteric liquid crystal display device in which a cholesteric liquid crystal is driven in a matrix manner by means of a plurality of common electrodes and segment electrodes, the common electrodes and segment electrodes being crossed oppositely, the method comprising the steps of:
writing display content to the cholesteric crystal by sequentially applying common electrode drive voltage waveforms from the common electrodes to the cholesteric liquid crystal display device, the common electrode drive voltage waveforms including a reset voltage waveform to cause the cholesteric liquid crystal to enter a homeotropic state, a select voltage waveform to select a final alignment state of the cholesteric liquid crystal, a hold voltage waveform to hold an alignment state selected by the select voltage waveform, and a non-select voltage waveform caused by a matrix drive; and
applying segment electrode drive voltage waveforms from the segment electrodes to the cholesteric liquid crystal display device during the step of writing the display content, the segment electrode drive voltage waveforms including at least an ON voltage waveform for determining the final alignment state of the cholesteric liquid crystal as a planar alignment state, and an OFF voltage waveform for determining the final alignment state as a focal conic state;
wherein the common electrode drive voltage waveforms are formed so that there is no period of time during which the same voltage is applied to all common electrodes at the same time in a period of time from the application of the hold voltage waveform to the first common electrode to the application of the reset voltage waveform to the last common electrodes, during the step of writing a display content, and the segment electrode drive voltage waveforms are formed so that there is a period of time during which the same voltage is applied to all segment electrodes at the same time during the step of writing the display content.

2. The method for driving a liquid crystal display device according to claim 1, wherein each of the reset, select, hold, non-select, ON and OFF voltage waveforms has the same number of unit intervals, each of the reset, select, hold, non-select voltage waveforms has two levels of voltages in the same unit interval, and each of the ON and OFF voltage waveforms has two or less levels of voltages in the same unit interval.

3. The method for driving a liquid crystal display device according to claim 2, wherein each of the reset, select, hold, and non-select voltage waveforms has two levels of voltages.

4. The method for driving a liquid crystal display device according to claim 2, wherein each of the reset, select, hold, and non-select voltage waveforms has three levels of voltages.

5. The method for driving a liquid crystal display device according to claim 2, wherein each of the reset, select, hold, and nonselect voltage waveforms has four levels of voltages.

6. The method for driving a liquid crystal display device according to claim 3, wherein the maximum voltage value of the reset voltage waveform and the maximum voltage value of the hold voltage waveform are the same.

7. The method for driving a liquid crystal display device according to claim 3, wherein each of the ON and OFF voltage waveforms has three or four levels of voltages.

8. The method for driving a liquid crystal display device according to claim 4, wherein each of the ON and OFF voltage waveforms has two levels of voltages.

9. The method for driving a liquid crystal display device according to claim 7, wherein the ON and OFF voltage waveforms and the non-select voltage waveform are the same.

10. The method for driving a liquid crystal display device according to claim 7, wherein the select and non-select voltage waveforms are the same.

11. A cholesteric liquid crystal display apparatus comprising: a liquid crystal display device in which a plurality of picture elements are formed at portions crossed by a plurality of common electrodes and a plurality of segment electrodes,
a common driver for writing display content to the picture elements by sequentially applying drive voltage waveforms from the common electrodes to the cholesteric liquid crystal display device, the drive voltage waveforms including a reset voltage waveform to cause the cholesteric liquid crystal to enter a homeotropic state, a select voltage waveform to select a final alignment state of the cholesteric liquid crystal, a hold voltage waveform to hold an alignment state selected by the select voltage waveform, and a non-select voltage waveform caused by a matrix drive;
a segment driver for applying drive voltage waveforms from the segment electrodes to the cholesteric liquid crystal display device during the step of writing the display content, the drive voltage waveforms including at least an ON voltage waveform for determining the final alignment state of the cholesteric liquid crystal as a planar alignment state, and an OFF voltage waveform for determining the final alignment state as a focal conic state; and
a controller for controlling the common driver and segment driver;
wherein the controller controls the common and segment driver in such a way that each of the reset, select, hold, non-select, ON and OFF voltage waveforms has the same number of unit intervals, each of the reset, select, hold, non-select voltage waveforms has two levels of voltages in the same unit interval, and each of the ON and OFF voltage waveforms has two or less levels of voltages in the same unit interval.

12. The cholesteric liquid crystal display apparatus according to claim 11, wherein the controller controls the common driver in such a way that there is no period of time during which the same voltage is applied to all common electrodes in a period of time from the application of the hold voltage waveform to the first common electrode to the application of the reset voltage waveform to the last common electrodes during a step of writing the display content, and that there is a period of time during which the same voltage is applied to all segment electrodes during the step of writing the display content.

13. The cholesteric liquid crystal display apparatus according to claim 12, wherein the controller controls the common driver in such a way that the voltages applied to the common electrodes have two levels of voltages.

14. The cholesteric liquid crystal display apparatus according to claim 12, wherein the controller controls the common driver in such a way that the voltages applied to the common electrodes have three levels of voltages Vh, Vm, V1 (Vh>Vm>V1), and include, for writing a display content, a unit interval during which the voltages applied to the common electrodes include Vh and Vm and a unit interval during which the voltages applied to the common electrodes include Vm and V1.

15. The cholesteric liquid crystal display apparatus according to claim 12, wherein the controller controls the common driver in such a way that the voltages applied to the common electrodes have three levels of voltages Vh, Vm, V1 (Vh>Vm>V1), and include, for writing a display content, a unit interval during which the voltages applied to the common electrodes include Vh and V1 and a unit interval during which the voltages applied to the common electrodes include Vm and V1.

16. The cholesteric liquid crystal display apparatus according to claim 12, wherein the controller controls the common driver in such a way that the voltages applied to the common electrodes have four levels of voltages Vh, Vmh, Vml, V1 (Vh>Vmh>Vml>V1), and include, for writing a display content, a unit interval during which the voltages applied to the common electrodes include Vh and V1, a unit interval during which the voltages applied to the common electrodes include Vml and V1, and a unit interval during which the voltages applied to the common electrodes include Vmh and Vml.

17. The cholesteric liquid crystal display apparatus according to claim 12, wherein the controller controls the segment driver in such a way that the voltages applied to the segment electrodes have four levels of voltages V1, V2, V3 V4 (V1>V2>V3>V4), and include, for writing a display content, a unit interval during which the voltages applied to the segment electrodes include V1, a unit interval during which the voltages applied to the segment electrodes include V1 and V2, and a unit interval during which the voltages applied to the segment electrodes include V3 and V4.

18. The cholesteric liquid crystal display apparatus according to claim 12, wherein the controller controls the segment driver in such a way that the voltages applied to the segment electrodes have three levels of voltages V1, V2, V4 (V1>V2>V4), and include, for writing a display content, a unit interval during which the voltages applied to the segment electrodes include V1, a unit interval during which the voltages applied to the segment electrodes include V2 and 4.

19. The cholesteric liquid crystal display apparatus according to claim 12, wherein the controller controls the segment driver in such a way that the voltages applied to the segment electrodes have three levels of voltages V1, V2, V4 (V1>V2>V4), and include, for writing a display content, a unit interval during which the voltages applied to the segment electrodes include V4, a unit interval during which the voltages applied to the segment electrodes include V1 and V2.

20. The cholesteric liquid crystal display apparatus according to claim 12, wherein the controller controls the segment driver in such a way that the voltages applied to the segment electrodes have three levels of voltages V1, V2, V4 (V1>V2>V4), and include, for writing a display content, a unit interval during which the voltages applied to the segment electrodes include V2, a unit interval during which the voltages applied to the segment electrodes include V4, and a unit interval during which the voltages applied to the segment electrodes include V1 and V2.

21. The cholesteric liquid crystal display apparatus according to claim 12, wherein the controller controls the segment driver in such a way that the voltages applied to the segment electrodes have three levels of voltages V1, V2, V4 (V1>V2>V4), and include, for writing a display content, a unit interval during which the voltages applied to the segment electrodes include V1, a unit interval during which the voltages applied to the segment electrodes include V2, a unit interval during which the voltages applied to the segment electrodes include V4, and a unit interval during which the voltages applied to the segment electrodes include V2 and V4.

22. The cholesteric liquid crystal display apparatus according to claim 12, wherein the controller controls the segment driver in such a way that the voltages applied to the segment electrodes have three levels of voltages V1, V2, V4 (V1>V2>V4), and include, for writing a display content, a unit interval during which the voltages applied to the segment electrodes include V1, a unit interval during which the voltages applied to the segment electrodes include V4, and a unit interval during which the voltages applied to the segment electrodes include V2 and V4.

23. The cholesteric liquid crystal display apparatus according to claim 12, wherein the controller controls the segment driver in such a way that the voltages applied to the segment electrodes have two levels of voltages.

24. The cholesteric liquid crystal display apparatus according to claim 11, wherein the controller controls the common and segment drivers in such a way that the voltages applied to the common and segment electrodes are 42 volts or less.
